(19) United States
(12) Patent Application Publication
(10) Pub. No.: US 2024/0046734 A1
(43) Pub. Date: Feb. 8, 2024

(54) DONER PREPARATION AND SERVICE AUTOMAT

(71) Applicant: ABM TECHNOLOGIES ILERI TEKNOLOJILER DIS TICARET ANONIM SIRKETI, Istanbul (TR)

(72) Inventor: YILDIZ Orhan, Istanbul (TR)

(21) Appl. No.: 18/247,751

(22) PCT Filed: Oct. 21, 2020
(86) PCT No.: PCT/TR2020/050970

§ 371 Date: Apr. 4, 2023

(30) Foreign Application Priority Data
Oct. 21, 2020 (TR) 2020/16777

(51) Int. Cl. G07F 17/00; G07F 11/66

(52) U.S. Cl. CPC G07F 17/0078; G07F 11/66

(57) ABSTRACT

A doner preparation and service automat (100) with the ability to take orders, to prepare doner automatically and to serve the same, characterized in that, it comprises the following; at least one cutting mechanism (201) that enables to automatically cut the frozen doner batons (200) in the automat (100) according to the received order into slices of leaf doner; at least one bread section (300) that keeps the frozen breads in the automat (100) and supplies frozen bread according to the order; at least one cooking mechanism (204) that provides baking/heating the frozen leaf doner slices cut by the cutting mechanism (201) and frozen breads transferred from the bread section (300).

### TECHNICAL FIELD

The present invention in general relates to automats that are widely found in the public domain and have the ability of preparing food (generally “fast food”) and serving the same automatically. The invention more particularly relates to a doner preparation and service automat with the ability to prepare doner automatically and serving the same in a way such as portion, sandwich, pita, puffed bread, wrap etc.

### PRIOR ART

The automat can be described as a mechanical or electro-mechanical assembly that can be able to realize sequential or circular processes automatically. Automates that are widely used are the machines used for selling e.g. newspapers, soft drinks or food in public domains. In the state of the art, there are automats that automatically prepare particularly fast food type food (hamburger, hot dogs, sandwiches, pizza, noodles, pasta, soup etc.) and enable to serve the same.

Said food preparing and serving automats are generally used as follows;

The user's choosing the product that he/she requires via the order screen (for example touch screen) or buttons in the automat structure,

Activating the relevant mechanical or electro-mechanical assembly in the automat structure depending on the selection made by the user,

Delivering the food to the user through the service section of the automat which is automatically prepared by a series of processes (cutting, cooking, heating, packaging etc.) by the mechanical or electro-mechanical assembly.

Automats that have a general operating principle as mentioned above are different according to the food they serve and the food preparing methods. The preparation and serving doner by means of an automat has some difficulties when compared to other foods. Placing the doner batons (placed on the shish and uncut block doner, doner cone), cooking doner, cutting the same, portioning, sandwiching or wrapping and serving the same are all realized by means of a series of different operations. It is required to create appropriate mechanisms and operate the same synchronously so as to carry out these operations within an automat structure automatically. In the state of the art, there are some automat structures that are designed to carry out one or some of said processes.

In the state of the art, there is an assembly disclosed in the document with publication number U.S. Pat. No. 6,582,744 titled “Integrated cooking and cutting instrument for fast food doner kebab and method therefor”. Said assembly consists of units that enable to cook the rectangular prism meat blocks defined as meat box and slivering the same. However, in the assembly disclosed in the document with publication number U.S. Pat. No. 6,582,744, there is no solution for preparing sandwich or wrap for the service of cut meats, adding sauce and/or spice, packaging the same and cleaning the bench. Moreover, in said assembly, meat blocks are continuously cooked, thus the cooking setting must be changed continuously based on the order. In this sense, meat blocks that are constantly exposed to heat in the automat have the risk of spoilage and bacterial growth after a period of time.

In the state of the art, there is a machine disclosed in the document titled “Automatic doner kebab slicing machine” with publication number U.S. Pat. No. 9,675,207. Said machine has a mechanism that enables to automatically cut the doner batons that are cooked (into slices of leaf doner). However, there is no solution for preparing sandwich or wrap for the service of cut meats, adding sauce and/or spice, packaging the same and cleaning the bench.

In the state of the art, there is an automat disclosed in the document titled “Methods and apparatuses for preparing Shawarma, Gyros and Doner kebab sandwiches and meals” with publication number U.S. Pat. No. 9,950,437. Said automat operates as the automats known in the order receiving process. The user gives an order via an order module and payment is made. The doner baton which is being cooked is cut automatically and divided into portions and served to the user by being packed as a sandwich or a wrap. However, said automat does not have any solution for preparing sandwich or wrap for the service of cut meats, adding sauce and/or spice, packaging the same and cleaning the bench. Moreover, in said automat, doner batons are continuously cooked, thus the cooking setting must be changed continuously based on the order. In this sense, doner batons that are constantly exposed to heat in the automat have the risk of spoilage and bacterial growth after a period of time.

In the state of the art, there is a facility structure disclosed in the document titled “A process for large-scale automated production of frozen thin kebab slices” with publication number EP2352380B1. Said structure only provides thin slices to be cut and packed from a frozen meat block. Although a precooking (grill) section is disclosed in the document, this precooking process is only used for eliminating the fats around the meat before packing. In this context, said structure disclosed in the document with publication number EP2352380B1 is designed for a facility; it does not offer any solution for a food automat.

In the state of the art, there is a food packaging mechanism (especially wrap) disclosed in the document titled “Edible food wrapper” with publication number GB2539647A. This mechanism provides a solution for wrapping the foods with a cylindrical shape but does not offer any other solution.

As can be seen, in the state of the art, there is no such a structure particularly for doner preparation and service that carries out all processes completely and automatically. Moreover, continuously exposing doner to heat in the current automats and not finding any solution for cleaning increase the risk of food spoilage and bacterial growth.

### BRIEF DESCRIPTION OF THE INVENTION

The present invention relates to a doner preparation and service automat which is developed for the preparation of doner order, packaging and service of the same automatically. The inventive automat is a full automatic mechanism that allows the user to give an order directly and to serve the doner order that is prepared unmanned in the automat fully compatible with the selections of the user.

The most important characteristic of the inventive automat that differs from the state of the art is that doner baton is in a frozen state. Doner baton that is found in a frozen state in the automat is not exposed to heat. Therefore, no risks such as meat spoilage or bacterial growth are in question.

The doner baton kept frozen in the automat is cut in frozen form when an order is received. Said cutting operation is performed by means of a cutting mechanism. The cutting mechanism cuts leaf doner slices from the frozen doner baton. Food waste is prevented by performing the cutting operation from the frozen doner baton depending on the order received.

Cut frozen leaf doner slices are transferred to the cooking mechanism. The cooking mechanism enables the frozen leaf doner slices to be baked/heated in an edible manner. Leaf doner slices are cooked by moving on slowly within the cooking mechanism that is operating at a predetermined and/or adjustable temperature. Thus the cooking degree of doner slices can be set. Moreover, since the cooking mechanism has a conveyor that moves along, it ensures to prevent accumulation of orders and to serve properly in the correct order.

Sandwich breads, puffed breads, flat breads, pitas, tortillas, lavashes etc. (hereinafter all of them will be referred to as bread) are also kept frozen in the automat. When an order is received, bread suitable for the order (bread or pita or lavash) is selected and it is transferred to the cooking mechanism. Thus bread that is kept in frozen form is served by heating the same. The cooking mechanism in which breads and leaf doner slices are heated can be a single mechanism or can have separate structures. It is important to keep the bread frozen and heat the same when an order is received so as to prevent food waste.

An important characteristic of the invention is that although the cooking mechanism in which breads and leaf doner slices are heated can be a single mechanism, the conveyors that are used to carry the same can be designed in separate structures. The conveyor on which the breads are carried reaches to the sandwich combining section earlier than the conveyor on which leaf doner slices are carried. Thus, during sandwich combining (sandwich forming), leaf doner slices can be placed within the bread.

The sauce, garniture and spice adding mechanism (hereinafter will be referred to as extra adding mechanism) enables to make additions to the doner bread in accordance with the order at the sandwich combining section.

The doner to which sauce, garniture and spice is added according to the order is served to the user through the product output after it is packed by taking the same to the rolling and packaging section.

When all of these operations are completed and the order is served to the user; conveyors, cooking mechanism, sandwich combining section, extra adding mechanism, packaging section and product output are automatically cleaned one by one or in a certain combination or completely. Thus hygiene is provided in the automat.

An important characteristic of the user is that; the product preparation steps are provided automatically and different units required for the preparation of doner order operate in coordination and synchronously.

The user can follow the preparation steps of the product that is ordered via the order screen. Moreover, the user can reach the automat remotely and can give order remotely via the mobile application and/or website. In this case, the closest automat to the location of the user detects the user's order and the order is prepared and served within the arrival duration of the user to the relevant automat.

The inventive doner automat has an appropriate structure so as to position the same in public domain such as shopping centres, park, street, campus etc.

The present invention is described in detail here in the following with reference to the figures by way of example. The inventive doner preparation and service automat is not limited to the form shown in the figures attracted herein to the document. The figures are presented for illustrative purposes.

### DESCRIPTION OF THE FIGURES

FIG. 1 is a representative view of the doner preparation and service automat.

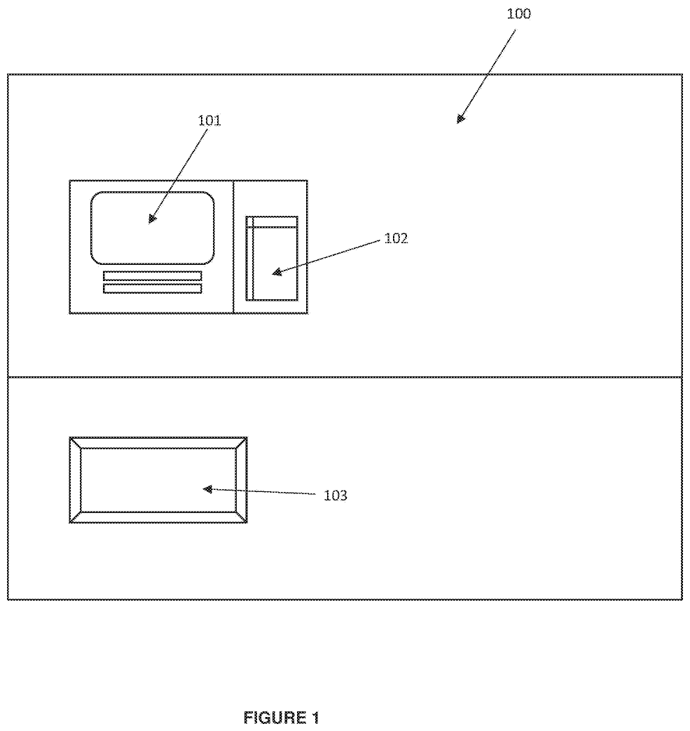

FIG. 2 is a representative view of the frozen doner batons, cutting mechanism, conveyors on which leaf doner slices are carried and cooking mechanism.

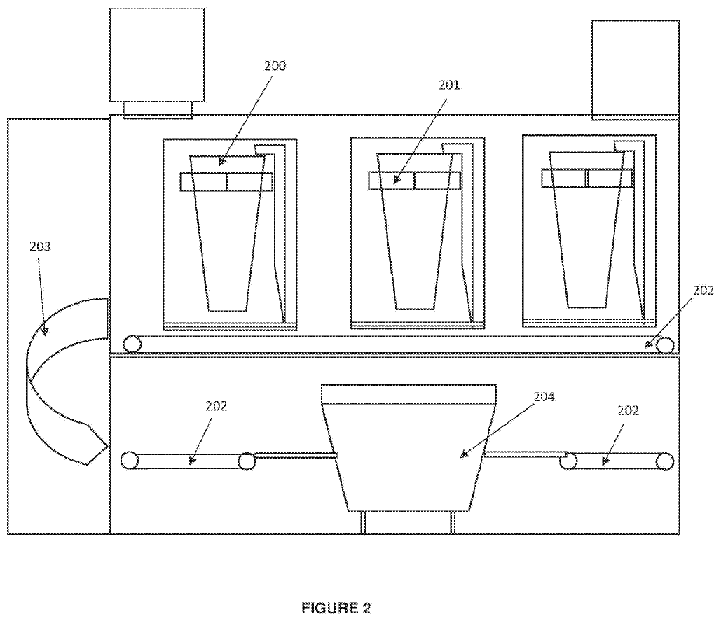

FIG. 3 is a representative view of the frozen bread section, conveyors on which breads are carried and cooking mechanism.

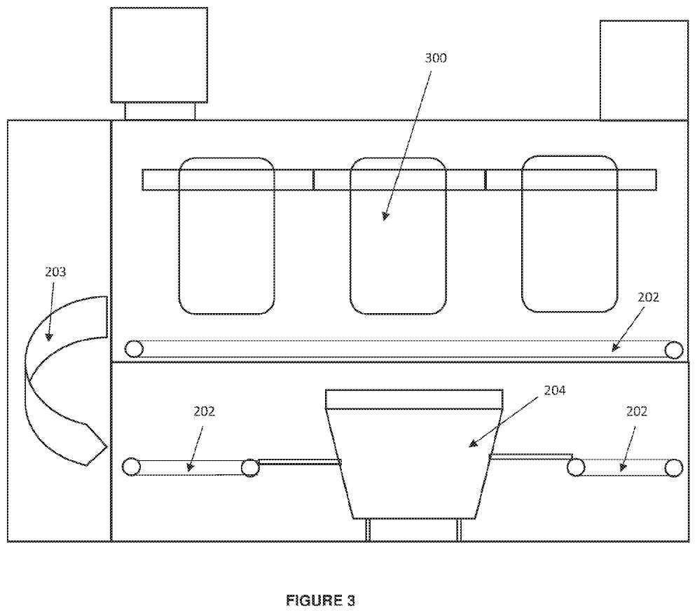

FIG. 4 is a representative view of the extra adding mechanism, conveyors on which sandwiches are carried, packaging section and product output.

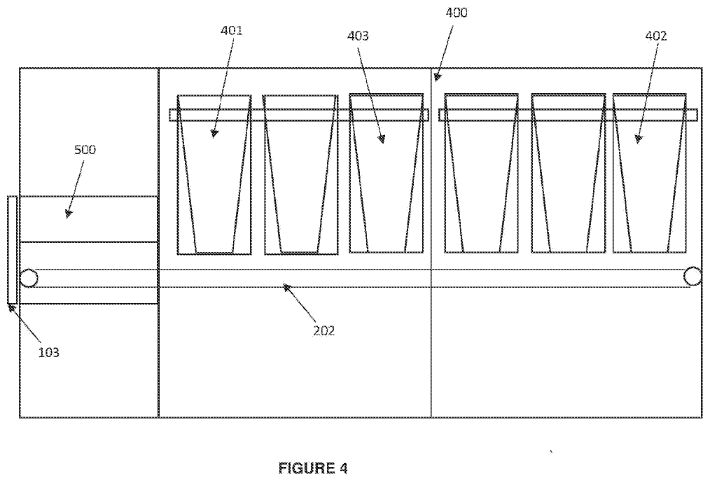

Description of the References

| NO | PART NAME |
|---|---|
| 100 | Automat |
| 101 | Order Screen |
| 102 | Payment unit |
| 103 | Product output |
| 200 | Doner baton |
| 201 | Cutting mechanism |
| 202 | Conveyor |
| 203 | Vertical conveyor |
| 204 | Cooking mechanism |
| 300 | Bread section |
| 400 | Extra adding mechanism |
| 401 | Sauce unit |
| 402 | Garniture unit |
| 403 | Spice unit |
| 500 | Packaging section |

### DETAILED DESCRIPTION OF THE INVENTION

The invention relates to a doner preparation and service automat (100) with the ability to take orders, to prepare doner automatically and to serve the same, characterized in that; it comprises the following;

At least one order screen (101) that is located on the external wall of the automat (100) and allows the user to give order to the automat (100) unmanned and to follow the steps regarding the order;

At least one payment unit (102) that is located on the external wall of the automat (100) and allows the user to make payment in terms of the order given,

At least one product output (103) that is located outside the automat (100) such that the user can be able to reach and enables the user to receive the order in a manner such that it is in a fully prepared and packed condition;

At least one cutting mechanism (201) that enables to automatically cut the frozen doner batons (200) in the automat (100) according to the received order into slices of leaf doner;

At least one bread section (300) that keeps the frozen breads in the automat (100) and supplies frozen bread according to the order;

At least one cooking mechanism (204) that bakes/heats the frozen leaf doner slices cut by the cutting mechanism (201) and frozen breads transferred from the bread section (300);

At least one conveyor (202) that enables to transfer the frozen leaf doner slices cut by the cutting mechanism (201) and frozen breads transferred from the bread section (300) to the cooking mechanism (204), to proceed in the cooking mechanism (204) and moving the same from the cooking mechanism (204) to the product output (103);

At least one vertical conveyor (203) that enables to position some sections in the automat (100) on the top of each other such that the dimensions of the automat (100) are not extended during delivery of the frozen leaf doner slices cut by the cutting mechanism (201) and frozen breads transferred from the bread section (300) from the cooking mechanism (204) to the product output (103);

At least one sandwich combining section that positions the leaf doner slices on/into the breads so as to form sandwich during the progress of leaf doner slices and breads on the conveyor (202) that exit from the cooking mechanism (204) in a baked/heated manner;

An extra adding mechanism (400) that provides addition of sauce and/or garniture and/or spice to the product in the form of doner sandwich/doner wrap in the sandwich combining section according to the order;

At least one sauce unit (401) that provides addition of sauce to the product in the form of doner sandwich/doner wrap in the sandwich combining section according to the order;

At least one garniture unit (402) that provides addition of garniture to the product in the form of doner sandwich/doner wrap in the sandwich combining section according to the order;

At least one spice unit (403) that provides addition of spice to the product in the form of doner sandwich/doner wrap in the sandwich combining section according to the order;

At least one packaging section (500) that packs and/or wraps the product prepared based on the order before serving the same to the user;

Processor that enables the operation of all mechanisms and units respectively and in a coordinated manner from the order received to the service to user comply with the order;

Remote connection module that allows the user to give order through the mobile application and/or web site via automat (100) remotely;

Cleaning mechanism that automatically cleans the cutting mechanism (201), conveyor (202), vertical conveyors (203) cooking mechanism (204), sandwich combining section, extra adding mechanism (400), packaging section (500) and product output (103) one by one or in a certain combination or completely, when all of these operations are completed and the order is served to the user.

Aspects of the invention, aims and versions of these aspects are as follows;

The automat (100) is appropriate to be positioned in public domain such as shopping center, park, campus, business center, gas station, recreation area, hotel, holiday village etc.

The user sees at least one order screen (101) when he/she approaches the automat (100). In a preferred embodiment of the invention, the order screen (101) is designed as a touch screen. However in the versions of the invention, the order screen (101) may be in the form of non-touch screen and buttons or digital indicators or only buttons etc. The user may select the desired features from the order screen (101) (cooking degree, weight, portion, and sandwich or wrap supply type, garniture, sauce, spice etc.). Moreover, the user can follow the preparation status of the order from the order screen (101).

When the user gives order via the order screen (101), he/she makes the payment by means of the payment unit (102). The payment unit (102) may have payment options such as cash and/or credit card and/or contactless payment and/or mobile payment and/or meal card.

The doner batons (200) are kept frozen in the automat (100). When the order is received by the automat (100), the cutting mechanism (201) is activated by the processor. The cutting mechanism (201) cuts leaf doner slices with appropriate weight regarding the order from the frozen doner baton (200). The cutting machine (201) makes automatic cutting according to the order.

The frozen leaf doner slices cut by the cutting mechanism (201) fall onto the conveyor (202). In a preferred embodiment of the invention, the conveyor (202) is designed as a carrying mechanism that moves along in the belt form. However, in different versions of the invention, conveyor (202) can be in the form of a carrying apparatus consisting of chambers and/or vertical conveyor (203) and/or transport assembly with hanger and/or other carrying assembly. Moreover, the vertical conveyors (203) that are contained in the structure so as to provide perpendicular passage provide positioning the units on top of each other so as to have an automat (100) with appropriate dimensions.

The frozen leaf doner slices carried with the conveyor (202) are passed through cooking mechanism (204) for cooking/heating process. The conveyor (202) progresses in the cooking mechanism (204) and provides the frozen leaf doner slices to be heated/cooked in the cooking mechanism (204) by means of moving along. Heat setting of the cooking mechanism (204) and the speed of the conveyor (202) in the cooking mechanism (204) are determined by the processor in accordance with the feature of the order.

The product which is named as bread in this description and covers sandwich breads, puffed breads, flat breads, pitas, tortillas, lavashes etc. are kept frozen in the bread section (300) in the automat (100). When the order is received, the properly frozen bread/breads are transferred to the conveyor (202). The conveyor (202) that carries the breads and leaf doner slices can be a single structure or can have separate structures. The frozen breads carried with the conveyor (202) are passed through cooking mechanism (204) for cooking/heating process. The conveyor (202) moves along in the cooking mechanism (204) and provides the frozen breads to be heated/cooked in the cooking mechanism (204) by means of moving along. The cooking mechanism (204) in which the breads and leaf doner slices are heated/cooked can be a single structure or can have separate structures.

The heated/cooked leaf doner slices and heated/cooked bread/beads are combined in the sandwich combining section. The conveyors (202) that carry the breads enable the breads to arrive at the sandwich combining section before the leaf doner slices. Thus, the leaf doner slices can be transferred such that they are brought in/on the breads.

The bread and leaf doner slices combined in the sandwich combining section are passed through the extra adding mechanism (400) again by means of the conveyors (202). The extra adding mechanism (400) consists of the following; a sauce unit (401) that provides adding sauces such as ketchup, mayonnaise, yoghurt sauce, hot sauce etc. to the product depending on the order and/or a garniture unit (402) that provides adding garniture such as tomato, pepper, greenery, fried potatoes etc. to the product depending on the order and/or a spice unit (403) that provides adding spices such as black pepper, thyme, chili pepper, mint etc. to the product depending on the order. The sauce, garnitures and spices selected by the user via the order screen (101) are included in the product by means of extra adding mechanism (400). Extra adding processes are performed automatically by means of the units arranged in order during the progress of the sandwich/wrap on the conveyor (202).

The order (sandwich or wrap) completed by adding the extras is taken to the packaging section (500) by means of conveyors (202). The sandwich/wrap can be wrapped and/or packaged in the packaging section (500). The order is wrapped and/or packaged fully in the packaging section (500) so as to be eaten with hand. This selection can also be made by the user via the order screen (101).

The packaged order is transferred to the product output (103) of the automat (100) and is served to the user. The product output (103) can be in the form of a platform or an elevator or a chamber with a cover.

When all of these operations are completed and the order is served to the user; the cutting mechanism (201), conveyor (202), vertical conveyors (203) cooking mechanism (204), sandwich combining section, extra adding mechanism (400), packaging section (500) and product output (103) are automatically cleaned one by one or in a certain combination or completely. Said cleaning process is realized by means of a cleaning mechanism. The cleaning mechanism consists of automatically running cleaner applicator (spray, pulverisation, gel squeezing etc.) and cleaning apparatuses (brush, sponge, steel wool etc.).

Moreover, order can be given to the automat (100) by means of remote access. The user can give order through the mobile application and/or website via automat (100) by remote connection. This function is provided by means of the remote connection module included in the structure of the automat (100).

The adjectives mentioned in the description as “top”, “bottom”, “front”, “rear”, “inner”, “outer”, “side” etc. do not define any priority, direction and/or order so as to limit the invention. The expressions are used in this manner so as to clarify the embodiment of the invention.

1. A doner preparation and service automat (100) with the ability to take orders, to prepare doner automatically and to serve the same, characterized in that; it comprises the following;
At least one cutting mechanism (201) that enables to automatically cut the frozen doner batons (200) in the automat (100) according to the received order into slices of leaf doner;
At least one bread section (300) that keeps the frozen breads in the automat (100) and supplies frozen bread according to the order;
At least one cooking mechanism (204) that provides baking/heating the frozen leaf doner slices cut by the cutting mechanism (201) and frozen breads transferred from the bread section (300).

2. Doner preparation and service automat (100) according to claim 1;
characterized in that; it comprises the following;
At least one order screen (101) that is located on the external wall of the automat (100) and allows the user to give order to the automat (100) unmanned and to follow the steps regarding the order;
At least one payment unit (102) that is located on the external wall of the automat (100) and allows the user to make payment in terms of the order given.

3. Doner preparation and service automat (100) according to claim 1; characterized in that; it comprises at least one product output (103) that is located outside the automat (100) such that the user can be able to reach and allows the user to receive the order in a manner such that it is in a fully prepared and packed condition.

4. Doner preparation and service automat (100) according to claim 3; characterized in that; it comprises at least one conveyor (202) that enables to transfer the frozen leaf doner slices cut by the cutting mechanism (201) and frozen breads transferred from the bread section (300) to the cooking mechanism (204), to move them along in the cooking mechanism (204) and to transfer the same from the cooking mechanism (204) to the product output (103).

5. Doner preparation and service automat (100) according to claim 4; characterized in that; it comprises at least one vertical conveyor (203) that enables to position some sections in the automat (100) on the top of each other such that the dimensions of the automat (100) are not extended during delivery of the frozen leaf doner slices cut by the cutting mechanism (201) and frozen breads transferred from the bread section (300) from the cooking mechanism (204) to the product output (103).

6. Doner preparation and service automat (100) according to claim 4; characterized in that; it comprises at least one sandwich combining section that positions the leaf doner slices on/into the breads so as to form sandwich during the progress of leaf doner slices and breads on the conveyor (202) that exit from the cooking mechanism (204) in a baked/heated manner.

7. Doner preparation and service automat (100) according to claim 1; characterized in that; it comprises an extra adding mechanism (400) that provides addition of sauce and/or garniture and/or spice to the product in the form of doner sandwich/doner wrap in the sandwich combining section according to the order.

8. Doner preparation and service automat (100) according to claim 7; characterized in that; it comprises the following;
At least one sauce unit (401) that provides addition of sauce to the product in the form of doner sandwich/doner wrap in the sandwich combining section according to the order and/or;
At least one garniture unit (402) that provides addition of garniture to the product in the form of doner sandwich/doner wrap in the sandwich combining section according to the order and/or;
At least one spice unit (403) that provides addition of spice to the product in the form of doner sandwich/doner wrap in the sandwich combining section according to the order and/or.

9. Doner preparation and service automat (100) according to claim 1; characterized in that; it comprises at least one packaging section (500) that packs and/or wraps the product prepared based on the order before serving the same to the user.9.

10. Doner preparation and service automat (100) according to claim 1; characterized in that; it comprises a processor that enables the operation of all mechanisms and units respectively and in a coordinated manner from the order received to the service to user in accordance with the order.

11. Doner preparation and service automat (100) according to claim 1; characterized in that; it comprises a cleaning mechanism that automatically cleans the cutting mechanism (201), conveyor (202), vertical conveyors (203) cooking mechanism (204), sandwich combining section, extra adding mechanism (400), packaging section (500) and product output (103) one by one or in a certain combination or completely, when all operations are completed and the order is served to the user.

12. Doner preparation and service automat (100) according to claim 2; characterized in that; it comprises a remote connection module that allows the user to give order via the mobile application and/or website by the automat (100) remotely.

13. Doner preparation and service automat (100) according to claim 6; characterized in that; it comprises conveyors (202) that enable the breads to be delivered to the sandwich combining section earlier than the conveyors (202) that carry the leaf doner slices so as to transfer the leaf doner slice to be brought in/on the breads in the sandwich combining section.
